(19) United States
(12) Patent Application Publication
(10) Pub. No.: US 2026/0292219 A1
(43) Pub. Date: Sep. 24, 2026

(54) Methods and Apparatus for Video Coding Improvement by Storing Information and Implicit Derivation

(71) Applicant: MEDIATEK INC., Hsinchu City (TW)

(72) Inventors: Man-Shu CHIANG, Hsinchu City (TW); Hsin-Yi TSENG, Hsinchu City (TW); Chia-Ming TSAI, Hsinchu City (TW); Cheng-Yen CHUANG, Hsinchu City (TW); Chih-Wei HSU, Hsinchu City (TW); Yi-Wen CHEN, San Jose, CA (US)

(21) Appl. No.: 19/472,326

(22) PCT Filed: Jul. 5, 2024
(86) PCT No.: PCT/CN2024/103783

§ 371 Date: Oct. 3, 2025

Related U.S. Application Data
(60) Provisional application No. 63/511,921, filed on Jul. 5, 2023.

(51) Int. Cl. H04N 19/186; H04N 19/172; H04N 19/176; H04N 19/593

(52) U.S. Cl. CPC H04N 19/186; H04N 19/172; H04N 19/176; H04N 19/593

(57) ABSTRACT

A method and apparatus for coding colour pictures or video using coding tools including one or more cross component models related modes are disclosed. According to this method, input data associated with a current block comprising a first-colour block and a second-colour block is receiving, wherein the input data comprise pixel data to be encoded at an encoder side or data associated with the current block to be decoded at a decoder side. A target CCP (Cross-Component Prediction) model for the current block is determined. The target CCP model is stored. The second-colour block is encoded or decoded by using target prediction generated according to the target CCP model for the current block.

### CROSS REFERENCE TO RELATED APPLICATIONS

The present invention is a non-Provisional application of and claims priority to U.S. Provisional Patent Application No. 63/511,921, filed on Jul. 5, 2023. The U.S. Provisional Patent Application is hereby incorporated by reference in its entirety.

### FIELD OF THE INVENTION

The present invention relates to video coding system. In particular, the present invention relates to coding for a chroma component with cross-component information stored.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

In order to improve the coding performance and/or to reduce complexity for a system using cross-component models, methods and apparatus of storing information and/or implicit derivation for cross-component models of chroma blocks are disclosed.

### BRIEF SUMMARY OF THE INVENTION

A method and apparatus for coding colour pictures or video using coding tools including one or more cross component models related modes are disclosed. According to this method, input data associated with a current block comprising a first-colour block and a second-colour block is receiving, wherein the input data comprise pixel data to be encoded at an encoder side or data associated with the current block to be decoded at a decoder side. The current block is coded in a non-intra mode. A target CCP (Cross-Component Prediction) model for the current block is determined. The target CCP model is stored. The second-colour block is encoded or decoded by using target prediction generated according to the target CCP model for the current block.

In one embodiment, the target CCP model comprises cross-component mode information, CCM (Cross-Component Model) information, or both.

In one embodiment, the target CCP model corresponds to a self-derived cross-component model or inherited cross-component model.

In one embodiment, the target CCP model comprises CCM (Cross-Component Model) information of inherited cross-component models and model parameters. In one embodiment, the CCM information of the inherited cross-component models comprise CCLM (Cross-Component Linear Model), CCCM (Convolutional Cross-Component Model), CCCM with different filters, or a combination thereof. In another embodiment, the CCM information is refined based on CCM information stored previously.

In one embodiment, inherited model parameters associated with CCM (Cross-Component Model) information are refined. In one embodiment, the inherited model parameters are refined with different types of templates and/or different number of lines.

In one embodiment, the target CCP model corresponds to an inherited cross-component model from chroma intra fusion mode. In one embodiment, the chroma intra fusion mode is derived by fusing a non-cross-component coded intra prediction and a cross-component coded intra prediction. In one embodiment, when inheriting CCM information from a block or position coded by the chroma intra fusion mode, model parameters for obtaining cross-component coded intra prediction are inherited and further refined.

In one embodiment, the stored target CCP model is used or referenced by one or more following coding blocks.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 shows 16 gradient patterns for GLM.

FIG. 3 shows an exemplary system block diagram for Cross-component residual model (CCRM).

FIG. 4 illustrates an example of template and its reference samples used in TIMD.

FIG. 5 illustrates the 5 neighbouring blocks used for deriving spatial merge candidates for VVC.

FIG. 6 illustrates an exemplary pattern of the spatial merge candidates.

FIG. 7 illustrates an example of temporal candidate derivation, where a scaled motion vector is derived according to POC (Picture Order Count) distances.

FIG. 8 illustrate the positions for the temporal candidate selected between candidates C₀ and C₁.

FIG. 9 illustrates an example of proposed weighting setting according to an embodiment of the present invention.

FIG. 10 illustrates an example of inheriting temporal neighbouring model parameters.

FIGS. 11A-B illustrates two search patterns for inheriting non-adjacent spatial neighbouring models.

FIG. 12 illustrates an example of restricting temporal candidates to only refer the CCM information in the collocated CTU, in Area1, in Area2 or in Area3.

FIG. 13 illustrates and example of storing the inter coding or CCM information in CTU-level buffer to picture-level buffer, where the left-above position marked in each 2×2 grid is saved to the picture-level buffer.

FIG. 14 illustrates a flowchart of an exemplary video coding system that stores cross-component model information to be used or referenced by one or more following coding blocks according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### Cross-Component Linear Model (CCLM) Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {Rec}_{L}^{′} ( i , j ) + β \qquad ( 1 )$$

where pred_{C}(i, j) represents the predicted chroma samples in a CU and rec_{L}′(i, j) represents the downsampled reconstructed luma samples of the same CU.

The CCLM parameters (α and β) are derived with at most four neighbouring chroma samples and their corresponding down-sampled luma samples. Suppose the current chroma block dimensions are W×H, then W′ and H′ are set as
W′=W, H′=H when LM_LA mode is applied;
W′=W+H when LM_A mode is applied;
H′=H+W when LM_L mode is applied.

### Multiple Model CCLM (MMLM)

In the JEM (J. Chen, E. Alshina, G. J. Sullivan, J.-R. Ohm, and J. Boyce, Algorithm Description of Joint Exploration Test Model 7, document JVET-G1001, ITU-T/ISO/IEC Joint Video Exploration Team (JVET), July 2017), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples.

Threshold is calculated as the average value of the neighbouring reconstructed luma samples. A neighbouring sample with Rec′_{L}[x,y]<=Threshold is classified into group 1; while a neighbouring sample with Rec′_{L}[x,y]>Threshold is classified into group 2.

$$\{ \begin{matrix}P r e {d}_{C} [ x , y ] = {a}_{1} \times {Rec}_{L}^{′} [ x , y ] + {β}_{1} if {Rec}_{L}^{′} [ x , y ] \leq Threshold \\ P r e {d}_{C} [ x , y ] = {a}_{2} \times {Rec}_{L}^{′} [ x , y ] + {β}_{2} if {Rec}_{L}^{′} [ x , y ] > Threshold\end{matrix} \qquad ( 2 )$$

### Local Illumination Compensation (LIC)

Local Illumination Compensation (LIC) is a method to do inter predict by using neighbour samples of current block and reference block. It is based on a linear model using a scaling factor a and an offset b. It derives the scaling factor a and an offset b by referring to the neighbour samples of current block and reference block. Moreover, it's enabled or disabled adaptively for each CU.

For more detail for LIC, it can refer to the document JVET-C1001 (Jianle Chen, et al., “Algorithm Description of Joint Exploration Test Model 3”, Joint Video Exploration Team (JVET) of ITU-T SG 16 WP 3 and ISO/IEC JTC 1/SC 29/WG 11, 3rd Meeting: Geneva, CH, 26 May-1 Jun. 2016, Document: JVET-C1001).

### Convolutional Cross-Component Model (CCCM)

In CCCM, a convolutional model is applied to improve the chroma prediction performance. The convolutional model has 7-tap filter consist of a 5-tap plus sign shape spatial component, a nonlinear term and a bias term.

Output of the filter is calculated as a convolution between the filter coefficients and the input values and clipped to the range of valid chroma samples.

The filter coefficients are calculated by minimising MSE between predicted and reconstructed chroma samples in the reference area.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in Enhanced Compression Model (ECM), however LDL decomposition was chosen instead of Cholesky decomposition to avoid using square root operations.

### Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged:

$$C = α \cdot G + β .$$

For signalling, when the CCLM mode is enabled to the current CU, two flags are signalled separately for Cb and Cr components to indicate whether GLM is enabled to each component; if the GLM is enabled for one component, one syntax element is further signalled to select one of 16 gradient filters (210-240) for the gradient calculation as shown in FIG. 2. The GLM can be combined with the existing CCLM by signalling one extra flag in bitstream. When such combination is applied, the filter coefficients that are used to derive the input luma samples of the linear model are calculated as the combination of the selected gradient filter of the GLM and the down-sampling filter of the CCLM.

### Intra Block Copy

Intra block copy (IBC) is a tool adopted in HEVC extensions on screen content coding (SCC). It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector is rounded to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

### Cross-Component Residual Model (CCRM)

As in JVET-AD0108 (Pekka Astola, et. al., “AHG12: Cross-component residual model (CCRM) for inter prediction”, Joint Video Experts Team (JVET) of ITU-T SG 16 WP 3 and ISO/IEC JTC 1/SC 29, 30th Meeting, Antalya, TR, 21-28 Apr. 2023, Document: JVET-AD0108), it is to apply cross-component residual model (CCRM) to predict chroma samples from reconstructed luma samples when the block uses inter prediction or intra block copy (IBC). FIG. 3 illustrates the decoder side of the method. The cross-component filters are derived using the prediction signals of luma and chroma. The derived filters are applied to the reconstructed luma signal producing the final chroma predictions. Filter coefficients are derived in step 320 for each chroma component separately using the prediction signals (i.e., predY 310, and predCb 312 or predCr 314) and the filters are applied to the reconstructed luma signal in step 330 as shown in FIG. 3. The reconstructed luma signal is formed by combining the luma prediction (PredY) 310 and residual luma signal (resY) using an adder 322. After applying the filters, the step 330 generates filtered-predicted Cb 340 and filtered-predicted Cr 350. The reconstructed Cb signal is formed by combining the filtered-predicted Cb 340 and residual Cb signal (i.e., resCb) using an adder 342. Similarly, the reconstructed Cr signal is formed by combining the filtered-predicted Cr 350 and residual Cr signal (i.e., resCr) using an adder 352.

### Chroma DM Mode

For Chroma DM mode, the intra prediction mode of the corresponding (collocated) luma block covering the centre position of the current chroma block is directly inherited.

Decoder Side Intra Mode derivation (DIMD)

To implicitly derive the intra prediction modes of a block, a texture gradient analysis is performed at both encoder and decoder sides. This process starts with an empty Histogram of Gradient (HoG) with 65 entries, corresponding to the 65 angular modes. Amplitudes of these entries are determined during the texture gradient analysis.

### Template-Based Intra Mode Derivation (TIMD)

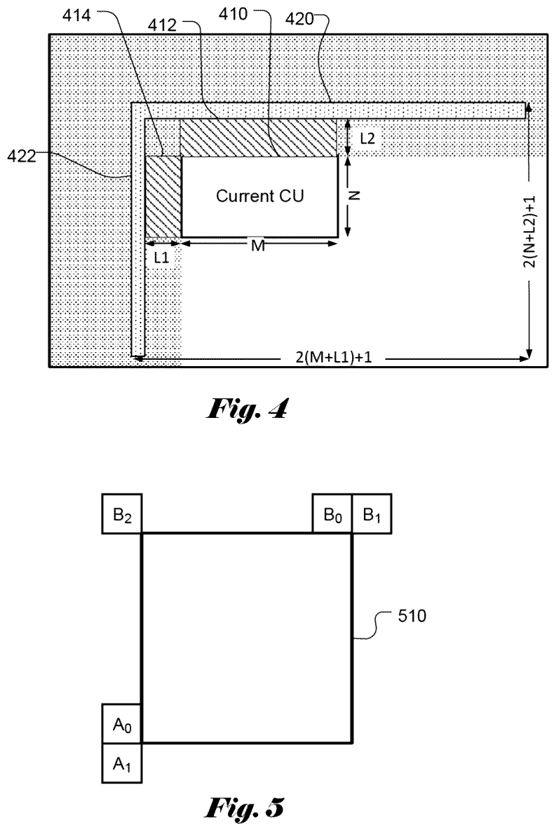

Template-based Intra Mode Derivation (TIMD) mode implicitly derives the intra prediction mode of a CU by using a neighbouring template at both the encoder and decoder, instead of signalling exact intra prediction mode bits to the decoder. As shown in FIG. 4, the prediction samples of the template are generated using the reference samples of the template for each candidate mode. A cost is calculated as the SATD between the prediction and the reconstruction samples of the template. The intra prediction mode with the minimum cost is selected as the TIMD mode (similar to the derivation method for the DIMD mode) and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode is implicitly derived from MPM list. As shown in FIG. 4, the prediction samples of the template (412 and 414) for the current block 410 are generated using the reference samples (420 and 422) of the template for each candidate mode.

### Intra Template Matching

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

### Inter Prediction Overview

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

The following text provides the details or refinement on some inter prediction methods.

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

### Spatial Candidate Derivation

The derivation of spatial merge candidates in VVC is the same as that in HEVC except that the positions of first two merge candidates are swapped. A maximum of four merge candidates (B_{0,} A_{0,} B₁ and A₁) for current CU 510 are selected among candidates located in the positions depicted in FIG. 5. The order of derivation is B_{0,} A_{0,} B_{1,} A₁ and B₂. Position B₂ is considered only when one or more neighbouring CU of positions B₀, A₀, B₁, A₁ are not available (e.g. belonging to another slice or tile) or is intra coded. After candidate at position A₁ is added, the addition of the remaining candidates is subject to a redundancy check which ensures that candidates with the same motion information are excluded from the list so that coding efficiency is improved.

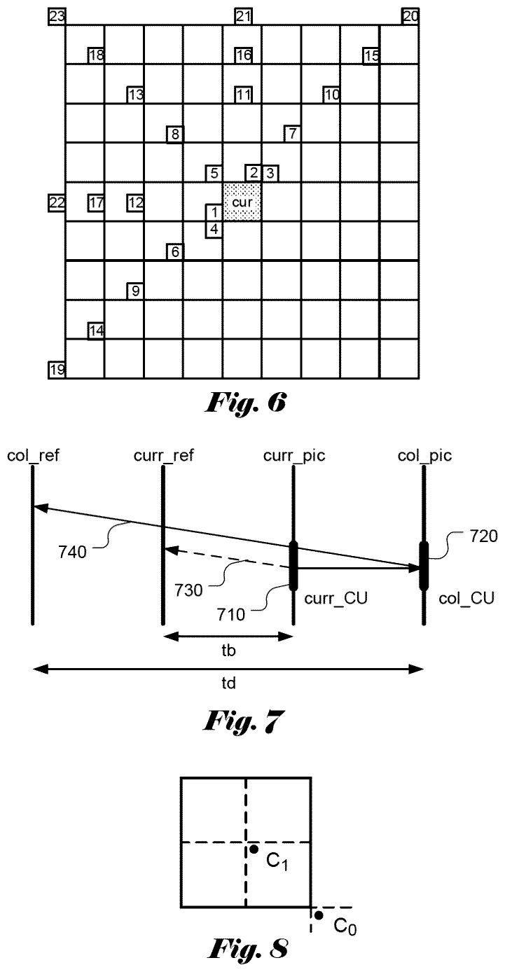

In addition to the above-mentioned spatial candidates, the non-adjacent spatial merge candidates as in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0399) are inserted after the TMVP in the regular merge candidate list. An example of the pattern of spatial merge candidates is shown in FIG. 6. The distances between non-adjacent spatial candidates and current coding block are based on the width and height of current coding block. The line buffer restriction is not applied.

### Temporal Candidates Derivation

In this step, only one candidate is added to the list. Particularly, in the derivation of this temporal merge candidate for a current CU 710, a scaled motion vector is derived based on the co-located CU 720 belonging to the collocated reference picture as shown in FIG. 7. The reference picture list and the reference index to be used for the derivation of the co-located CU is explicitly signalled in the slice header. The scaled motion vector 730 for the temporal merge candidate is obtained as illustrated by the dotted line in FIG. 7, which is scaled from the motion vector 740 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 8. If CU at position C₀ is not available, is intra coded, or is outside of the current row of CTUs, position C₁ is used. Otherwise, position C₀ is used in the derivation of the temporal merge candidate.

### History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

### Pair-Wise Average Merge Candidates Derivation

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

### Merge Estimation Region

Merge Estimation Region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is greater than (yCb>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.

In order to improve the coding performance or reduce the complexity of cross-component prediction, various schemes are disclosed.

The cross-component information is used to improve prediction accuracy of a non-intra block, for example, an inter block. In an example of improving the prediction accuracy of the chroma component of the inter block, the luma information from the corresponding luma component and/or the chroma information from the previous coded chroma component are used.
The first scheme is that for a coding unit (under single tree splitting) including luma (Y) and chroma (Cb and/or Cr) components, the prediction for Cb and/or Cr is improved by using the information from Y.
The second scheme is that for a coding unit (under single tree splitting) including luma (Y) and chroma (Cb and/or Cr) components or for a coding unit (under chroma dual tree splitting) including chroma (Cb and/or Cr) components, the prediction for Cr is improved by using the information from Cb. For example, deriving model parameters by using neighbouring reconstructed samples of Cb and Cr as the inputs X, as the source terms, and Y, as the target, of model derivation. Then generating Cr prediction by the derived model parameters and Cb reconstructed samples.

In the following, several embodiments related to the first scheme are proposed to use an inherited cross-component mode for the current chroma block by a) building a candidate list for the current block where the candidate list includes cross-component models, b) selecting one or more model information in the list, and/or c) using the model information (similar to intra chroma cross-component mode) to generate one or more hypotheses of predictions for the current chroma component (Cb or Cr) by applying and/or modifying the selected model information to the reconstructed or predicted samples for the corresponding luma component. When the selected model information refers to traditional cross-component linear model(s), the proposed method is called as inter cross-component linear model (inter CCLM) mode. When the selected model information refers to convolutional cross-component model(s) derived by a regression-based method (as CCCM for example), the proposed method is called as inter cross-component convolution model (inter CCCM) mode. Moreover, in some embodiments, a self-derived (re-derived) cross-component mode is proposed and can be added into the candidate list in Section I. In some embodiments, the selection of using the proposed inherited mode, for example, using the model of inheriting from the previous block, and/or using the proposed self-derived mode, for example, using the model of deriving by the current block, is determined following an explicit rule, an implicit rule, or both. More details are described in Section IV.

In one embodiment, the proposed embodiments can also be used for the second scheme by using the previous coded chroma component (Cb) as the luma component in the first scheme.

### Storage of the Model for the Current Block

In another embodiment, when the current non-intra block, for example, an inter block, uses the model parameters from the self-derived cross-component mode, the used model parameters can be saved and/or referenced by the following coding blocks. For an example of the self-derived cross-component mode being CCRM, all or any subset of the model parameters can be saved. If the following coding block is intra, it is allowed to use the saved model parameters. If the following coding block is inter or any other mode-type (e.g. IBC), it is allowed to use the saved model parameters. In one sub-embodiment, if the following block and the reference block containing the saved model parameters belong to different mode types (e.g. one being intra and one being inter), the buffers for storing the model parameters can be different.

In another embodiment, when the current non-intra block, for example, an inter block, uses the inherited cross-component mode, the used model parameters can be saved and/or referenced by the following coding blocks. For an example of the inherited CCCM, all or any subset of the model parameters can be saved. If the following coding block is intra, it is allowed to use the saved model parameters. If the following coding block is inter or any other mode-type (e.g. IBC), it is allowed to use the saved model parameters. In one sub-embodiment, if the following block and the reference block containing the saved model parameters belong to different mode types (e.g. one being intra and one being inter), the buffers for storing the model parameters can be different.

### I. Building a Candidate List Including Cross-Component Models

In one embodiment, when building the merge-like candidate model list (modelList), one or more than one of the following candidate model information are included.
Spatial model information from spatial neighbour blocks (corresponding to “Spatial MVP from spatial neighbour CUs” for inter)
Temporal model information from collocated blocks (corresponding to “Temporal MVP from collocated CUs” for inter)
History-based model information from a FIFO table (corresponding to “History-based MVP from a FIFO table” for inter)
Pairwise average model information (corresponding to “Pairwise average MVP” for inter)
Default model information (corresponding to “Zero MVs” for inter)

In one sub-embodiment of the candidate type being “Spatial model information from spatial neighbour blocks”, a valid spatial neighbouring block(s) can be from one of spatial adjacent and/or non-adjacent neighbours (or any subset of the blocks in a neighboring search region for the current block) which satisfies a pre-defined condition. For example, the pre-defined condition is that the neighbour is coded by a cross-component mode (such as CCLM, MMLM, CCCM, GLM, the mode with mode information inherited from a merge-like candidate list, MH CCLM which refers multiple cross-component models or multiple hypotheses of cross-component prediction are used to generate predictors of a MH CCLM block, and/or any cross-component mode with syntax not belonging to traditional (non-cross-component) intra prediction modes) or combining with a cross-component mode (such as chroma fusion (or named LM assisted Angular/Planar Mode) which refers fusing existing hypothesis of prediction with additional hypothesis of cross-component prediction to generate predictors of a chroma fusion block, inter CCLM, and/or any traditional mode with syntax not belonging to cross-component modes but using the cross-component information to generate the prediction). When scanning the spatial neighbouring blocks, a candidate is added into the list if the candidate is valid.

In another sub-embodiment of Temporal model information from collocated blocks, the collocated block is from the block in the reference picture or in the collocated picture as inter mode. For example, when the current block is coded by inter prediction mode, the collocated block is derived using or referred by the motion information (including the motion vectors and/or the reference picture) of the current block. If the current block is a subblock motion mode (e.g. affine mode), each subblock in the current block has its own collocated temporal model information and/or all or any subset of collocated temporal model information derived using or referred by the different subblock motions are added into the list. For another example, the temporal model information can be from the collocated block derived using or referred by the motion information of the neighbouring blocks for the current block. If the proposed methods are applied to an IBC block or any mode using block vectors, block vector information is used as motion vector where the block vector information is determined by signalling and/or template matching in a pre-defined searching range and/or any implicit or explicit pre-defined rules.

In another sub-embodiment of History-based model information, a history-based table (the FIFO table) is built and stores the model information from the previous coded blocks. The table can be reset at the beginning and/or end of a CTU (for example, each CTU or CTU row), slice, picture, tile, and/or sequence. One or more history-based candidates can be added into the candidate list by the order from the head to tail of the table or from the tail to head of the table.

In another sub-embodiment of Pairwise average model information, the model information of this candidate is derived based on the model information from more than one of the previous candidates in the list. For example, it can average and/or modify the model parameters of more than one candidate as the to-be-applied model parameters. For another example, it can combine more than one predictions as the final prediction, where each of more than one predictions is generated by applying one of models in the candidate list.

In another sub-embodiment, the default model information is added if the list is not full after inserting all pre-defined candidates. Some examples of the default CCLM model information show below:
For example, the default alpha (or named as α, a, or scaling parameters) are {0, ⅛, −⅛, 2/8, − 2/8, ⅜, −⅜, . . . }, and the beta (or named as β, b, or offset parameter) is based on the selected default alpha, averaging neighbouring reconstructed luma sample values, and/or averaging neighbouring reconstructed chroma (Cb/Cr) sample values.

In another sub-embodiment, details of the candidate list can be found in Section V.

In another sub-embodiment, when selecting one candidate from the list and using the model information from the candidate for the current block or when inheriting the model information from a previous coded block (when putting one candidate into the list), only a subset of the model information is inherited. For example, only the alpha is inherited. The beta is obtained for the current block through the inherited alpha, averaging neighbouring reconstructed luma sample values, and/or averaging neighbouring reconstructed chroma (Cb/Cr) sample values. For example, when inheriting MMLM model information, the scaling parameters and/or the classification threshold are inherited. The offset parameter in each class is derived according to the inherited classification threshold and the averaging neighbouring reconstructed luma sample values, and/or averaging neighbouring reconstructed chroma (Cb/Cr) sample values in each class. If no neighbouring reconstructed samples are available in a class, the offset parameter is directly inherited from the candidate. For example, when inheriting CCCM model information, all convolution parameters, offsets, and/or the classification threshold are inherited. For example, when inheriting GLM model information, if the GLM candidate is 3-parameter GLM mode, all the gradient pattern indices and model parameters are inherited; otherwise, if the GLM candidate is the 2-parameter GLM mode, the offset parameter is derived by using the inherited scaling parameter, averaging neighbouring reconstructed luma sample values, and/or averaging neighbouring reconstructed chroma (Cb/Cr) sample values. For example, when inheriting chroma fusion model information, the derived MMLM parameters are inherited and used as when inheriting a MMLM candidate for the current block.

In another sub-embodiment, when selecting one candidate from the list and using the model information from the candidate for the current block, all model information is inherited. For example, both the alpha and beta are inherited.

In another embodiment, for the current block being a larger block with block width, height, or area larger than a pre-defined threshold, the current block is split into multiple subblocks. For example, the splitting rule is that a minimum block size is pre-defined and the current block is split until the subblock width or height reaches the minimum block size. For another example, the splitting rule follows quad tree (4 subblocks) or binary tree (2 subblocks) splitting. In one sub-embodiment, each subblock will have its own list. In another embodiment, an implicit rule is defined to select the model (from the list) for each subblocks. For example, the implicit rule is to use the spatial model information for the subblocks near the top boundary or left boundary of the current block and/or use the temporal model information for the subblock (e.g. the subblock at the right-bottom portion of the current block) far away from the top boundary or left boundary of the current block. If the current block is split into 4 subblocks by quadtree, the subblock at the top-left uses the spatial candidate model from B₂, the subblock at the right-top uses the spatial candidate model from B₁ or B₀, the subblock at the left-bottom uses the spatial candidate model from A₁ or A₀, and/or the subblock at the right-bottom uses the temporal candidate model. Subblocks without any significant luma residual and/or cbf are skipped.

In another embodiment, when building modelList, one or more self-derived cross-component candidates are included. In one sub-embodiment, an example of the self-derived cross-component candidate is CCRM. The cross-component prediction (containing target predicted samples) of the current bock is formed by combining one or more proposed source terms and the models (referring to a proposed weighting setting). As shown in the equation (3), pred(i, j) is a target (predicted) sample in the current block which can be obtained after our proposed mechanism, sourceTermSet0 includes one or more source terms from luma component, sourceTermSet1 includes one or more source terms from chroma components, and biasTermSet includes one or more bias terms.

Equation (3) is just an example and our proposed mechanism can use any subset or extension of sourceTermSet0, sourceTermSet1, and biasTermSet. Each sample or any subset of samples in the current block gets its target (predicted) sample according to Equation (3):

$$pred ( i , j ) = ( s o u r ceTermSet 0 ( i , j ) + sourceTermSet 1 ( i , j ) + … + biasTermSet ) \qquad ( 3 )$$

with the proposed weighting setting, where (i, j) is a sample position in the current block.

In the following, the content of sourceTermSet0 is described in Section I.1, the content of sourceTermSet1 is described in Section I.2, the content of biasTermSet is described in Section I.3, and the predictor derivation using the proposed source terms and the proposed weighting setting is described in Section I.4. Several examples with our proposed mechanism are shown in Section I.4.

I.1. Content of sourceTermSet0(i, j)

SourceTermSet0(i, j) includes one or more luma source terms denoted as sourceTerm0₀, sourceTerm0₁, . . . , and/or sourceTerm0ₙ₋₁. The value of n means the number of taps for the source term set. In another embodiment, the pattern of the n taps refers to a pattern defined as any subset of a window region M×N around/including the position (i_{L}, j_{L}). If the target sample is chroma (e.g., cb or cr), (i_{L}, j_{L}) is the collocated luma position from (i, j).

For a source term in the source term set, the following embodiments are used to determine generation of source content.

In one embodiment, the source content is based on a predicted sample generated by a prediction mode and/or a reconstructed sample generated based on the predicted sample by a prediction mode and a reconstructed residual.

In another sub-embodiment, the source content is the filtered source or the source with any pre-processing. For example, the source content is the predicted/reconstructed sample after filtering with a pre-defined model or filter.

In another sub-embodiment, the source content is gradient information from the predicted samples and/or reconstructed samples.

In another sub-embodiment, since the target sample belongs to a chroma sample (e.g., Cb or Cr), the predicted sample and/or the reconstructed sample is located within the collocated (luma) block from the current (chroma) block. The predicted sample and/or the reconstructed sample is treated as an initial sample and used as source content to generate the target sample.

In another embodiment, the values of the source terms are further adjusted (e.g. added or subtracted) by a pre-defined offset.

In another embodiment, the source term may further include location information.

I.2. Content of sourceTermSet1(i, j)

SourceTermSet1(i, j) includes one or more chroma (Cb or Cr) source terms denoted as sourceTerm0₀, sourceTerm0₁, . . . , and/or sourceTerm0ₘ₋₁. The value of m means the number of taps for the source term set. In one embodiment, the source terms can be linear terms and/or non-linear terms, only linear terms, and/or only non-linear terms. In another embodiment, the pattern of the m taps refers to a pattern defined as any subset of a window region M2×N2 around/including the position (i_{C}, j_{C}). If the target sample is chroma (Cb or Cr), (i_{C},j_{C}) is (i, j).

For a source term in the source term set, the following embodiments are used to determine generation of source content.

In one embodiment, the source content is based on a predicted sample generated by a prediction mode and/or a reconstructed sample generated based on the predicted sample by a prediction mode and a reconstructed residual.

In another sub-embodiment, the source content is the filtered source or the source with any pre-processing. For example, the source content is the predicted/reconstructed sample after filtering with a pre-defined model or filter.

In another sub-embodiment, the source content is gradient information from the predicted samples and/or reconstructed samples.

In another sub-embodiment, if the target sample belongs to a chroma sample, the predicted sample and/or the reconstructed sample is located within the current block. The predicted sample and/or the reconstructed sample is treated as an initial sample and used as source content to generate the target sample.

In another embodiment, the values of the source terms are further adjusted (e.g., added or subtracted) by a pre-defined offset.

In another embodiment, the source term may further include location information. For example, if the target sample refers to chroma, the horizontal location (i) of (i, j) is used in a source term and the vertical location (j) of (i, j) is used in a source term.

I.3. Content of biasTermSet

Bias term is a pre-defined value. In one embodiment, the bias term is a midValue according to bitDepth specified in the standard. For example, the bias term is set as (1<<(bitDepth−1)). In another embodiment, the bias term is the same for each sample in the current block. That is, the bias term is regardless of the position (i, j).

### I.4. Predictor Derivation for Sample (i, j)

### I.4.1. Proposed Weighting Setting

The proposed weighting setting is to estimate the relationship (minimize the distortion) between “the predicted and/or reconstructed samples on the reference region of the current (chroma) block” and “the predicted and/or reconstructed samples on the reference region of the corresponding luma block” by a pre-defined regression method, to generate a weighting (referring to model parameters) according to the regression method. The weighting on the source terms derived is then applied to get the target (predicted) samples in the current block. In one embodiment, the pre-defined regression method can be Linear Minimum Mean Square Error (LMMSE) method for CCLM or can be any unified method with the regression method used for CCLM. In another embodiment, the pre-defined regression method can be the LDL decomposition method for CCCM or can be any unified method with the regression method used for CCCM. In another embodiment, the pre-defined regression method can be Gaussian elimination.

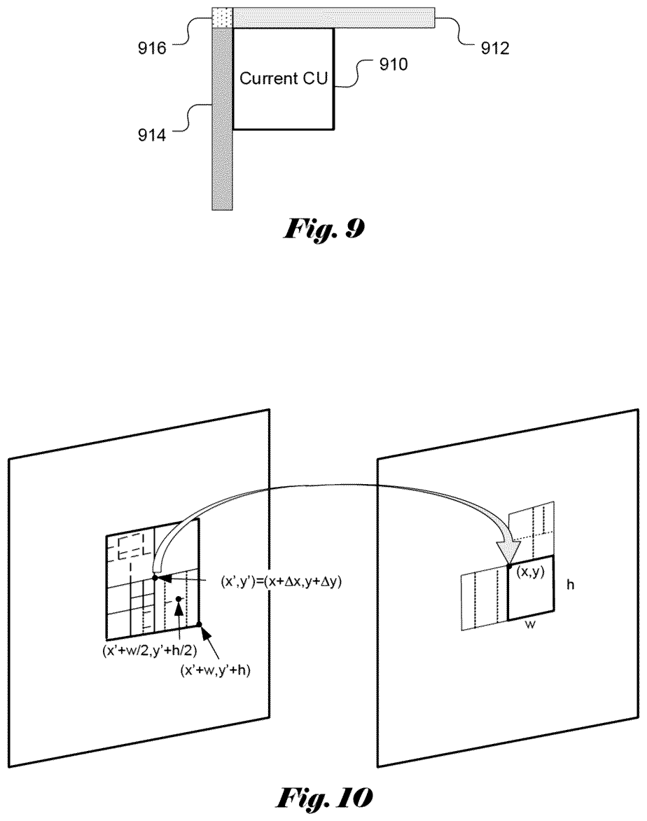

In one embodiment, the reference region of the current block is the spatial neighbouring region of the current block. The spatial neighbouring region of the current block 910 includes above reference region 912, left reference region 914, above-left reference region 916, and/or any subset of the above as shown in FIG. 9.

The reference region of the corresponding luma block is the spatial neighbouring region of the corresponding luma block.

In another embodiment, the reference region of the current (chroma) block is the vector-collocated region of the current block and the reference region of the corresponding luma block, which can be the collocated luma block of the current chroma block, is the vector-collocated region of the corresponding luma block. For inter coding unit containing luma and chroma blocks, the vector-collocated region of the current block refers to the motion compensated results by using the motion information (motion vectors and/or reference pictures) of the current block, and the vector-collocated region of the corresponding luma block refers to the motion compensated results by using the motion information (motion vectors and/or reference pictures) of the corresponding luma block. For IBC or intraTMP, the vector-collocated region of the current block refers to the motion compensated results by using the motion information (block vectors and/or current picture) of the current block, and the vector-collocated region of the corresponding luma block refers to the motion compensated results by using the motion information (block vectors and/or current picture) of the corresponding luma block.

In another embodiment, the above-proposed two kinds of the reference region of the current block can be used together. For example, generally, samples in the vector-collocated region of the current block are used as input samples when deriving model parameters; however, for a smaller block, samples in the spatial neighbouring reference region are used as additional input samples when deriving model parameters.

In another embodiment, more details of construction of the modelList can be found in Section VI.

### II. Signalling for Model Information Control

When not applying the proposed inter CCLM (or inter CCCM), the prediction of current block is from the original inter prediction.

In another embodiment, whether to apply inter CCLM or not depends on signalling.

In one sub-embodiment, the signalling refers to a coded TU and/or TB and/or CU and/or CB level flag. In another embodiment, inter CCLM (or inter CCCM) can be supported only when the size conditions of the current block are satisfied.

In one sub-embodiment, the size condition is that the block width, block height, or block area is larger than a pre-defined threshold. The predefine threshold can be a positive integer such as 8, 16, 32, 64, 128, 256, . . . .

In another sub-embodiment, the size condition is that the block width, block height, or block area is smaller than a pre-defined threshold. The predefine threshold can be a positive integer such as 8, 16, 32, 64, 128, 256, 512, 1024, 2048, 4096 . . . .

In another embodiment, original inter prediction (generated by motion compensation) is used for luma and the predictions of chroma components are generated by CCLM and/or any other cross-component models, for example, models from other LM modes.

In one sub-embodiment, the current CU is viewed as an inter CU, intra CU, or a new type of prediction mode (neither intra nor inter).

In another embodiment, as more proposed methods related to Section V, the one or more LM mode(s) (or cross-component mode(s)) which will be used to generate the one or more hypotheses of predictions for LM assisted Angular/Planar Mode and/or inter CCLM and/or MH CCLM are selected from a pre-defined merging candidate list (called modelList). One modelIdx is signalled to select a candidate from the candidate list (modelList) and the selected candidate is used for the current block. The modelList contains one or more candidates where each candidate refers to a model (or cross-component mode) information. If only one candidate is in the list (the size of the list is only 1), the modelIdx is not signalled, and/or the modelIdx can be inferred as 0 or a default value.

In one embodiment, when building modelList, one or more predefined candidates are added. The pre-defined candidates can include any subset/extension of the following candidates:
CCLM family: CCLM_LT, CCLM_L, CCLM_T
MMLM family: MMLM_LT, MMLM_L, MMLM_T
CCCM family: CCCM_LT, CCCM_L, CCCM_T

The above proposed methods can be also applied to IBC blocks or the blocks with any IBC sub-modes (e.g. IBC merge or IBC AMVP (or called IBC advanced MVP or IBC inter) or any IBC mode under IBC syntax). (“inter” in this invention can be changed to IBC.) That is, for chroma components, the block vector prediction can be combined or replaced with cross-component prediction.

### III. Generating Hypotheses of Predictions

### III.1. Concept

In one embodiment, prediction or reconstruction-based model is used to generate one hypothesis of prediction for the current chroma component.

In one sub-embodiment of a prediction based linear model, the derived model parameters are applied to the predicted samples for the first component (Y) to get the predicted samples for the second or third component:

$$P ( i , j ) = a \cdot pre {d}_{L}^{′} ( i , j ) + b .$$

The predicted samples for the first component are downsampling with the downsampling filters (which may be fixed at one-predefined filter or selected among some candidate filters).

In another sub-embodiment of a reconstruction based linear model, the derived model parameters are applied to the reconstructed samples for the first component (Y) to get the predicted samples for the second or third component:

$$P ( i , j ) = a \cdot {reco}_{L}^{′} ( i , j ) + b .$$

The reconstructed samples for the first component are down-sampling with the downsampling filters (which may be fixed at one-predefined filter or selected among some candidate filters).

Prediction or reconstruction based convolution model is similar to the proposed methods for the prediction or reconstruction based linear model. The main difference is that the model coefficient pattern follows CCCM (not CCLM) and the luma samples may or may not be down-sampled first. If not applying down-sampling to the luma samples, more taps (model coefficients) may be used to access the non-down-sampled luma samples.

### III.2. CCLM for Inter Block

CCLM for inter block can also be named as inter CCLM and “CCLM” can be extended to any LM mode (or any cross-component mode) or replaced with any LM mode (or any cross-component mode).

In one embodiment, for chroma components, in addition to original inter prediction (generated by motion compensation which can be uni-prediction and/or bi-prediction, multiple hypotheses of prediction from multiple motion candidates which may refer to one or more merge candidates and/or one or more AMVP candidates, and/or any combination of above, or which can be only uni-prediction), one or more hypotheses of predictions (generated by CCLM and/or any other LM modes) are used to output the current prediction.

In one sub-embodiment, the current prediction is the weighted sum of inter prediction and CCLM prediction.

In another embodiment, the inter prediction can be generated by any inter mode mentioned above. For example, the inter mode can be regular merge mode. For another example, the inter mode can be CIIP mode. For another example, the inter mode can be GPM or any GPM variations (e.g., GPM intra referring one prediction unit using intra prediction).

In another embodiment, inter CCLM is supported only when any one (or more than one) of the pre-defined inter mode is used for the current block, or inter CCLM is supported when any one (or more than one) of the enabling flag(s) of the pre-defined inter mode is (are) indicated as enabled. The meaning of supporting inter CCLM is that the prediction of the current block can be chosen between applying inter CCLM or not applying inter CCLM.

For another example, if CCLM mode is used for generating the chroma prediction samples and luma prediction is from an inter coding tool, a flag is used to indicate if the CCLM model used for the chroma prediction is inherited from the CCLM models used in the previous coded blocks or the CCLM model is from a predetermined CCLM mode. If the CCLM model is inherited from the CCLM models used in the previous coded blocks, an index is used to indicate which model in the list is inherited or modified. Otherwise, a predetermined CCLM mode is used to implicitly derive the CCLM model for the current chroma prediction.

IV. Selection of Using the Proposed Inherited Mode and/or Self-Derived Mode

In one embodiment, a flag can be signalled to indicate/select if the re-derived model is used. If the flag is 0, the cross-component model used to encode/decode the neighbour merge candidate is inherited. If the flag is 1, the re-derived method is used.

In another embodiment, an implicit rule (not using the additional flag) is used to determine whether to use the re-derived model.

In another embodiment for using the proposed method such as inherited or self-derived method, the candidate with the smallest cost or model error (e.g. the first candidate in the modelList) is implicitly selected to generate the cross-component prediction. For another example, an index is signalled to select one or more candidates from the modelList. More details can be found in Section II.

### V. Details of Cross-Component Model Information in Candidate List

### V.1. Inheriting CCM Information

In one embodiment, the cross-component model (CCM) information of inherited cross-component model can be stored together with the inherited model parameters. The CCM information can be inherited together with the inherited model parameters. The prediction of the current block can be generated based on the inherited CCM information and inherited model parameters. The CCM information can include but not limited to prediction mode (e.g., CCLM, MMLM, CCCM, 2-parameter GLM, 3-parameter GLM), model index for indicating which model shape is used in convolutional model, classification threshold for multi-model, information to indicate non-downsampled samples are used in convolutional model, down-sampling filter flag, down-sampling filtering index when multiple down-sampling filters are used, number of neighbouring lines used to derive model, types of templates used to derive model, post-filtering flag and model parameters.

In another embodiment, CCLM model can be inherited. In addition to storing model parameters, a prediction mode can be stored in the CCM information for indicating that the inherited model is a CCLM model.

In another embodiment, CCLM model with non-linear term can be inherited. In addition to storing model parameters, a prediction mode can be stored in the CCM information for indicating that the inherited model is a CCLM model with at least one non-linear term.

In another embodiment, CCCM model can be inherited. In addition to storing model parameters, a prediction mode can be stored in the CCM information for indicating that the inherited model is a CCCM model. The luma offset and the chroma offset used for adjusting the input of CCCM model can also be stored in the CCM information.

In another embodiment, CCCM model with a different convolution filter shape can be inherited. In addition to model parameters and prediction mode, a CCCM mode index can also be stored in CCM information for indicating which convolution filter shape is used for the inherited CCCM model. For example, a CCCM model with different convolution filter shape can only contain the spatial terms in the horizontal direction. For another example, a CCCM model with a different convolution filter shape can only contain the spatial terms in vertical direction. For another example, a CCCM model with a different convolution filter shape can only contain the spatial terms in the diagonal direction. For another example, a CCCM model with a different convolution filter shape can only contain the spatial terms in the anti-diagonal direction. For another example, a CCCM model with a different convolution filter shape can contain the X-shape spatial terms.

In another embodiment, CCCM model using non-downsampled samples can be inherited. In addition to storing model parameters, a prediction mode can be stored in the CCM information for indicating that the inherited model is a CCCM model using non-downsampled samples.

In another embodiment, CCCM model with multiple down-sampling filter can be inherited. In addition to storing model parameters, a prediction mode can be stored in the CCM information for indicating that the inherited model is a CCCM model with multiple down-sampling filter, and a model index can be also stored in CCM information for indicating which variant of CCCM model with multiple down-sampling filter is inherited.

In one embodiment, a mixed CCCM model consist of various terms (e.g., spatial term, gradient term, location term, non-linear term and bias term) can be inherited. The gradient term can be calculated in either the downsampled domain or the non-downsampled domain. The location term can be calculated with respect to the top-left coordinates of the current block or the picture. In addition to storing model parameters, a prediction mode can be stored in the CCM information to indicate that the inherited model is a mixed CCCM model consisting of various terms. If there are multiple types of mixed CCCM models, a model index can also be stored in the CCM information to indicate which type of mixed CCCM model is inherited. For example, gradient and location based CCCM (GL-CCCM) proposed in JVET-AB0119 (Ramin G. Youvalari, et al., “Non-EE2: Gradient and location based convolutional cross-component model (GL-CCCM) for intra prediction”, Joint Video Exploration Team (JVET) of ITU-T SG 16 WP 3 and ISO/IEC JTC 1/SC 29/WG 11, 28th Meeting, Mainz, DE, 20-28 Oct. 2022, Document: JVET-AB0119) is a mixed CCCM model which consist of one spatial term in centre position, two gradient terms for horizontal direction and vertical direction, two location term X and Y for the relative horizontal location and relative vertical location, one non-linear term and one bias term. A prediction mode can be stored in the CCM information to indicate that the inherited model is a GL-CCCM model.

In another embodiment, GLM model can be inherited. In addition to storing model parameters, a prediction mode can be stored in the CCM information for indicating that the inherited model is a GLM model, and a down-sampling filtering index can be also stored in CCM information for indicating which gradient down-sampled filter is used for the inherited GLM model.

In another embodiment, GLM model with luma term can be inherited. In addition to storing model parameters, a prediction mode can be stored in the CCM information for indicating that the inherited model is a GLM model with a luma term, and a down-sampling filtering index can be also stored in CCM information for indicating which gradient down-sampled filter is used for the inherited GLM model with the luma term.

In another embodiment, any kind of cross-component multi-model can be inherited. In addition to storing model parameters and prediction mode, a multi-model on/off flag can be stored in the CCM information for indicating whether the inherited CCM model is a multi-model or not. If the multi-model on/off flag is true, the multi-model classification threshold is also stored in the CCM information.

In another embodiment, the CCM information can include information to indicate how the inherited model is derived. For example, the CCM information can include the number of neighbouring lines used to derive the cross-component model and/or the types of templates used to derive model. For example, a set of templates can be used to derive a CCCM model. The set of templates include template with different positions, sizes, and shapes. The CCM information can store the index of the template which the inherited CCCM model was derived based on. For example, the inherited CCCM model can be derived based on a top-only template, or a left-only template or a left-and-top template. For another example, the inherited CCCM model can be derived based on a 6-line template or a 2-line template.

In another embodiment, a post-filter flag can be stored in the CCM information. This information describes how the inherited model is used in the block which the inherited model is from. If the post-filter flag is on, this indicates a filter is applied to the prediction of the block which the inherited model is from.

### V.2. Refinement of Inherited Model Parameters

In one embodiment, the inherited model parameters can be further refined based on the inherited CCM information. The inherited CCM information can include how the inherited model is derived, such as the type of template and/or the number of neighbouring lines used to derive the model. The refined parameters are derived based on local information. The refinement process can follow how the inherited model was derived and use the same type of template and/or the same number of neighbouring lines. For example, if the inherited model is CCLM and was derived based on left-only template (e.g. the inherited model is CCLM_L), the offset parameter β can be derived from the average value of neighbouring left-template reconstructed samples of the current block. For example, if the inherited model is CCLM and was derived based on top-only template (the inherited model is CCLM_T), the offset parameter β can be derived from the average value of neighbouring top-template reconstructed samples of the current block. For another example, if the inherited model is CCCM and was derived with 2-line template. The offset value (e.g. c₆ in CCCM where c₆ is the weight coefficient for the bias term) can be re-derived based on the 2-line template reconstructed samples of the current block. For another example, if the inherited model is a multi-model (MMLM, CCCM with multi-model) and was derived based on left-only template, the classification threshold can be re-derived based on the left-template reconstructed samples of the current block.

In another embodiment, the inherited model parameters are further refined with different types of templates and/or different number of lines, and the final model parameters are determined by the template cost. The template cost is computed by applying the candidate refined model parameters on the neighbouring template to predict the template samples and compute the difference (SAD or SATD) between the prediction and the reconstruction samples. For example, if the inherited model is CCLM, the refined offset parameter

$${β}_{L}^{′} , {β}_{T}^{′} , or {β}_{L T}^{′}$$

is derived using left-template, top-template and left-top template of the reconstruction samples of the current block respectively. If the template cost of applying

$${β}_{L}^{′}$$

is the minimum among

$${β}_{L}^{′} , {β}_{T}^{′} , and {β}_{L T}^{′} , then {β}_{L}^{′}$$

is chosen as the final offset parameter.

In another embodiment, the inherited model parameters can be further refined by a pre-defined value. The template cost is used to determine if the inherited model parameters are further refined. The template cost is computed by applying the candidate refined model parameters on the neighbouring template to predict the template samples and compute the difference (SAD or SATD) between the prediction and the reconstruction samples. For example, for CCCM mode, for each inherited model parameter cᵢ, the value is refined by dcᵢ, and the template costs of applying cᵢ+dcᵢ and cᵢ are compared to determine which is the final model parameter value.

### V.3. Inheriting Spatial Neighbouring Model Parameters

In one embodiment, the inherited model parameters can be from a block that is an immediate neighbouring block. The models from blocks at pre-defined positions are added into the candidate list in a pre-defined order.

In one embodiment, the pre-defined positions and the pre-defined order can be the same as those of spatial candidates for inter merge mode.

In one embodiment, assume the position, width and height of the current block are (x, y), W and H respectively, the pre-defined positions can include positions immediate above the current block, such as (x+W>>1, y−1) or (x+(W+1)>>1, y−1), if W is greater than or equal to a threshold TH. The pre-defined positions can also include positions immediate left to the current blocks, such as (x−1, y+H>>1) or (x−1, y+(H+1)>>1), if H is greater than or equal to a threshold TH. TH can be 2, 4, 8, 16, 32, or 64.

In one embodiment, there is a maximum number of inherited models from spatial neighbours that can be added into the candidate list, and the maximum number is smaller than the number of pre-defined positions.

### V.4. Inheriting Temporal Neighbouring Model Parameters

In one embodiment, if the current slice/picture is a non-intra slice/picture, the inherited model parameters can be from the block in the previous coded slices/pictures.

In one embodiment, the current block position is at (x, y) and the block size is w×h. The inherited model parameters can be from the block at some pre-defined positions of the previous coded slices/picture.

In one sub-embodiment, the pre-defined positions can be (x+Δx, y+Δy) or (x_{mid}+Δx, y_{mid}+Δy), where

$$( {x}_{mid} , {y}_{m i d} ) = ( x + \frac{w}{2} , y + \frac{h}{2} ) .$$

The two value sets αₓ and α_{y} are defined as:

$${α}_{x} = \{ {α}_{x 1} , {α}_{x 2} , {α}_{x 3} , … , {α}_{x n} \} , {α}_{x i} < {α}_{xj} if i < j ,$$

$${α}_{y} = \{ {α}_{y 1} , {α}_{y 2} , {α}_{y 3} , … , {α}_{y n} \} , {α}_{y i} < {α}_{yj} if i < j .$$

All values in αₓ and α_{y} are positive numbers.

For example, (Δx, Δy) can be (±αₓᵢ×w, ±α_{yi}×h), (±αₓᵢ×w, 0), (0, ±α_{yi}×h).

For another example, (Δx, Δy) can be (±αₓᵢ×δx, ±α_{yi}×δy), (±αₓᵢ×δx, 0), (0, ±α_{yi}×δy), where δx and δy are two fixed positive numbers.

For yet another example, αₓ=α_{y}, such as αₓ=α_{y}={1, 2, 3, 4, 5}.

For yet another example, αₓ≠α_{y}, such as

$${α}_{x} = \{ \frac{1}{2} , 1 , \frac{3}{2} , 2 , \frac{5}{2} \}$$

and α_{y}={1, 2, 3, 4, 5}.

In one sub-embodiment, the pre-defined positions (x′, y′) are inside the corresponding area of the current encoding/decoding block, i.e., x≤x′<x+w and y≤y′<y+h. The pre-defined positions can be (x, y), (x+w−1, y), (x, y+h−1), (x+w−1, y+h−1),

$$( x + \frac{w}{2} , y + \frac{h}{2} ) , ( x , y + \frac{h}{2} ) , ( x + \frac{w}{2} , y ) .$$

In one sub-embodiment, the pre-defined positions (x′, y′) are outside of the corresponding area of the current encoding/decoding block, i.e., x′<x+ or x′≥x+w, and y′<y or y′≥y+h. The pre-defined positions can be (x−1, y), (x, y−1), (x−1, y−1), (x+w, y), (x+w−1, y−1), (x+w, y−1), (x, y+h), (x−1, y+h−1), (x−1, y+h), (x+w, y+h−1), (x+w−1, y+h), (x+w, y+h).

In one embodiment, the models from the positions closer to (x, y) are added into the final merge candidate list first.

The previous coded picture, from which the inherited parameter model is obtained, is referred to as the collocated picture hereafter.

In one embodiment, the previous coded picture where the inherited parameter model is from, i.e., the collocated picture, is one of the pictures in the reference lists.

In one embodiment, the collocated picture is signalled in the picture/slice header. The reference list and the reference index are signalled in the picture/slice header. For example, the collocated picture is selected as L0[0]. For another example, the collocated picture is selected as L1[0].

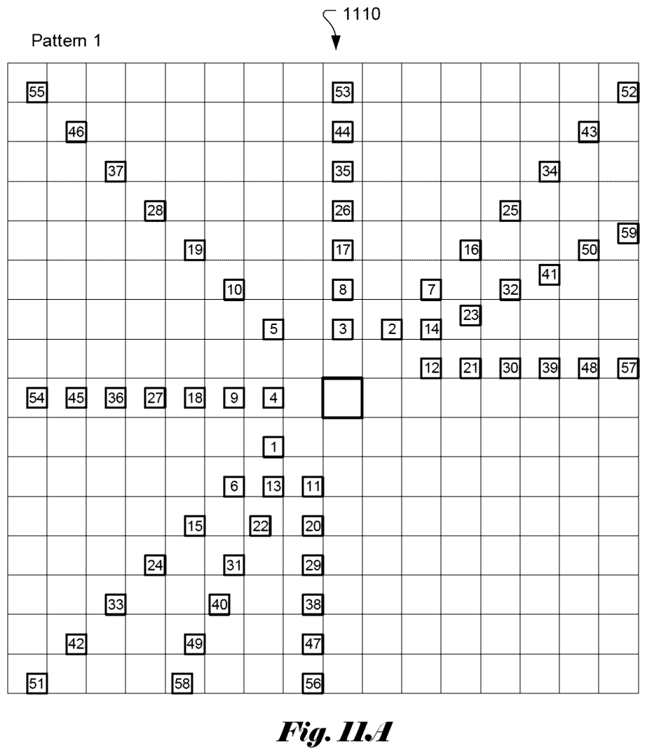

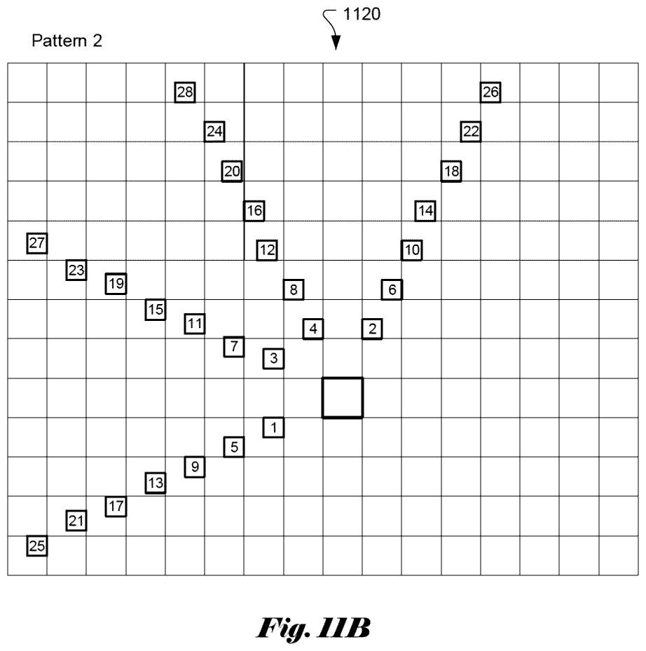

In one embodiment, as shown in the FIG. 10, the current block position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the previous coded slices/picture, where x′=x+Δx and y′=y+Δy.

In one sub-embodiment, if the prediction mode of the current block is inter, Δx and Δy are set to the horizontal and vertical motion vector of the current block.

In another sub-embodiment, if the current block is inter bi-prediction, Δx and Δy are set to the horizontal and vertical motion vector in reference picture list 0.

In another sub-embodiment, if the current block is inter bi-prediction, Δx and Δy are set to the horizontal and vertical motion vector in reference picture list 1.

### V.5. Inheriting Non-Adjacent Spatial Neighbouring Models

In one embodiment, the inherited model parameters can be from blocks that are non-adjacent spatial neighbouring blocks. The models from blocks at pre-defined positions are added into the candidate list in a pre-defined order.

In one sub-embodiment, the pre-defined positions and the pre-defined order are the same as those of non-adjacent spatial neighbouring candidates for inter merge mode.

In one sub-embodiment, the pre-defined positions and the pre-defined order are as depicted in FIG. 11A and FIG. 11B. The positions of the numbered squares are the pre-defined positions. The number inside each square indicate the pre-defined order. Positions in Pattern 1 (1110) is added into the list before positions in Pattern 2 (1120). The distance between each pre-defined positions are proportional to the width and height of the current block.

In one embodiment, there is a maximum number of inherited models from non-adjacent spatial neighbours that can be added into the candidate list, and the maximum number is smaller than the number of pre-defined positions.

V.6 Inheriting Model Parameters from History Table

In one embodiment, the inherited model parameters can be from a cross-component model history table. The history table stores CCM information of valid previous coded blocks. The valid previous coded block refers to any blocks containing valid CCM information. The cross-component models in the history table can be added into the candidate list according to a pre-defined order. In one embodiment, the adding order of historical candidate can be from the beginning of the table to the end of the table. In another embodiment, the adding order of historical candidate can be from the end of the table to the beginning of the table.

In one embodiment, one cross-component model history table can be maintained for storing the previous cross-component model (i.e., CCM information), and the cross-component model history table can be reset at the start of the current picture, current slice, current tile, every M CTU rows or every N CTUs, N and M can be any value greater than 0. In another embodiment, the cross-component model history table can be reset at the end of the current picture, current slice, current tile, current CTU row or current CTU.

In another embodiment, multiple history table are used for storing different type of cross-component model. For example, the first history table is used for storing single model, and the second history table is used for storing multi-model. For another example, the first history table is used for storing gradient model, and the second history table is used for storing non-gradient model. For another example, the first history table is used for storing simple linear model (e.g., y=ax+b), and the second history table is used for storing complicated model (e.g., CCCM).

In one embodiment, when adding historical candidates from multiple history tables to the candidate list, the adding order can be from the beginning of to the end of a certain table, and then the next history table is added in the same order or in a reversed order.

V.7 Inheriting from Fusion Mode

Fusion mode refers to mode that fuses two predictions to generate the final prediction. In the chroma intra fusion mode, a chroma intra prediction that is not generated using a cross-component prediction (CCP) coding tool (e.g., CCLM, MMLM, CCCM) is fused with another chroma intra prediction generated using a cross-component prediction coding tool. For example, a non-CCLM coded intra prediction and a CCLM coded intra prediction are fused together to obtain the final intra prediction.

In the chroma intra fusion mode, a non-CCLM coded intra prediction and a CCLM coded intra prediction are fused together to obtain the final intra prediction. In one embodiment, when inheriting the cross-component model parameters from the block/position coded by chroma intra fusion mode, the model parameters for obtaining the CCLM coded intra prediction are inherited and further refined. In another embodiment, the fusion weight, the coding mode of non-CCLM coded intra prediction and the model parameters for obtaining the CCLM coded intra prediction are inherited and further refined. In still another embodiment, the coding mode of non-CCLM coded intra prediction is implicitly derived (e.g., derived as DM or planar mode), and the fusion weight and the model parameters for obtaining the CCLM coded intra prediction are inherited and further refined. In still another embodiment, if the non-CCLM coded intra prediction of the block/position coded by chroma intra fusion mode can be implicitly derived (e.g., the non-CCLM coded intra prediction is DM or planar mode), the fusion weight and the model parameters for obtaining the CCLM coded intra prediction are inherited and further refined.

In one embodiment, when inheriting the cross-component model parameters from the block/position coded by chroma intra fusion mode, the model parameters for obtaining the CCP coded intra prediction are inherited and further refined.

In one embodiment, in addition to inheriting and/or refining the CCP model parameters, the fusion weight and/or the coding mode of non-CCP coded intra prediction are also inherited. That is, the chroma intra fusion mode is inherited.

### V.8 Limiting the Requirement of Buffer/Storage Resource

To limit the requirement of buffer/storage resource, the available range for including temporal candidates should be constrained. The temporal candidates mentioned in this section refer to candidates that inherit model parameters from the block in the previous coded slices/pictures as described in Section entitled “Inheriting temporal neighbouring model parameters”. For example, assume the current block position is at (x, y), the positions in the previous coded slices/pictures, where the inherited parameter model is from, can be (x+Δxᵢ, y+Δyᵢ), i is from 1 to M, and M is a positive integer greater than 0. Δxᵢ and Δyᵢ are pre-defined displacements. For another example, assume the current block position is at (x, y), the positions in the previous coded slices/pictures, where the inherited parameter model is from, can be (x+dx+Δxᵢ, y+dy+Δyᵢ), i is from 1 to M, and M is a positive integer greater than 0. Δxᵢ and Δyᵢ are pre-defined displacements. dx and dy are determined by a motion vector of a neighbouring block of the current block. The details of how to determine the motion vector is in Section entitled “Inheriting temporal neighbouring model parameters”. For another example, assume the current block position is at (x, y), the positions in the previous coded slices/pictures, where the inherited parameter model is from, can be (x+dx+Δxᵢ, y+dy+Δyᵢ), i is from 1 to M, and M is a positive integer greater than 0. Δxᵢ and Δyᵢ are pre-defined displacements.

In one embodiment, if the prediction mode of the current block is inter, dx and dy are set to the horizontal and vertical parts of motion vector of the current block. If the horizontal part or the vertical part of the motion vector is fractional, dx is set to the horizontal part of the motion vector after rounding and dy is set to the vertical part of the motion vector after rounding. The rounding method used can be but not limited to the following methods: rounding toward negative infinity, rounding toward positive infinity, rounding toward zero, rounding to the nearest integer (e.g., rounding away from zero, rounding half up, rounding half down, . . . ), or rounding to the nearest pre-defined precision (e.g., round to the nearest k-pixel or 1/k-pixel precision position, where k can be 2, 4, 8, 16, or 32). If the prediction mode of the current block is IBC, dx and dy are set to the horizontal and vertical block vector of the current block. If the horizontal part or the vertical part of the block vector is fractional, dx is set to the horizontal part of the block vector after rounding and dy is set to the vertical part of the block vector after rounding. The rounding method used can be, but not limited to, the following methods: rounding toward negative infinity, rounding toward positive infinity, rounding toward zero, rounding to the nearest integer (e.g., rounding away from zero, rounding half up, rounding half down, . . . ), or rounding to the nearest pre-defined precision (e.g., round to the nearest k-pixel or 1/k-pixel precision position, where k can be 2, 4, 8, 16, or 32).

In one embodiment, only the cross-component model (CCM) information of the collocated picture in the CTU whose position in the collocated picture corresponds to the position of the current encoding/decoding CTU in the current picture can be referenced by temporal candidates. In another embodiment, only the CCM information of the collocated picture in the CTUs whose positions in the collocated picture correspond to the position of current encoding/decoding CTU, and/or left N CTUs, and/or right M CTUs in current picture can be referenced by temporal candidates, where N and M can be any integer greater than 0. In another embodiment, only the CCM information of the collocated picture in the CTU row whose position in collocated picture corresponds to the position of current encoding/decoding CTU row in current picture can be referenced by temporal candidates. In another embodiment, only the positions in collocated picture correspond to current CTU row and/or the above N CTU rows and/or below M CTU rows of the current picture can be referenced, where N and M can be any integer greater than 0. Note, as described in Section entitled “Inheriting CCM information” and Section entitled “Refinement of inherited model parameters”, the CCM information mentioned in this disclosure includes, but not limited to, prediction mode (e.g., CCLM, MMLM, CCCM), GLM pattern index, model parameters, or classification threshold.

In FIG. 12, the collocated CTU refers to the CTU in the collocated picture whose position corresponds to the position of the current encoding/decoding CTU in the current picture. Let the position of the top-left and bottom left corner of the collocated CTU be (x_{L}, y_{T}) and (x_{L}, y_{B}) respectively. Let the picture width be w. The x, y ranges for each dotted area in FIG. 12 are defined as following:

$$Area 1 : {x}_{L} - N \leq x < w , {y}_{T} \leq y < {y}_{T}$$

$$Area 2 : {x}_{L} - N \leq x < {x}_{L} , {y}_{T} \leq y \leq {y}_{B}$$

$$Area 3 : 0 \leq x < {x}_{L} - N , {y}_{B} < y \leq {y}_{B}$$

N is any positive integer, N>0.

In one embodiment, the temporal candidates could only refer the CCM information in the collocated CTU, in Area1, in Area2 or in Area3, as depicted in FIG. 12. N is set to a pre-defined value. For example, N is set to the minimum allowed block size in the standard. The block can be CU/PU/TU. For another example, N is set to 4. In one embodiment, the region from which the temporal candidates can refer the CCM information is the same as the region from which the temporal motion vector can be referred in inter mode.

V.9 Sharing Buffer Resource with Existing Coding Tools

To store the CCM information (e.g., prediction mode, related sub-mode flags, prediction pattern, or model parameters) for further model inheritance, the buffer for storing inter coding information (e.g., motion vector buffer) is shared with cross-component information inheritance (or called cross-component (CC) merge mode) for storing CCM information. Suppose the minimal allowed block size is m×n, the current CTU size is p×q, and the current picture size is r×s. A CTU-level buffer and picture-level buffers are used for storing the inter coding and CCM information of the current CTU and each picture, respectively. A CTU-level buffer is created for storing the final inter coding or CCM information, and this CTU-level buffer size is ┌p/m┐×┌q/n┐. A picture-level buffer is created for storing the final inter coding or CCM information of the current picture, and this picture-level buffer size is ┌r/i┐×┌s/j┐, where i≥m and j≥n. After encoding or decoding the current block, the inter coding or CCM information of the current block is firstly saved to the corresponding positions of CTU-level buffer in unit of m×n, where the corresponding positions are the positions covered by the current block in unit of m×n. Later, after encoding or decoding the current CTU, the inter coding or CCM information in the current CTU-level buffer are saved to the corresponding positions of the picture-level buffer in unit of i×j.

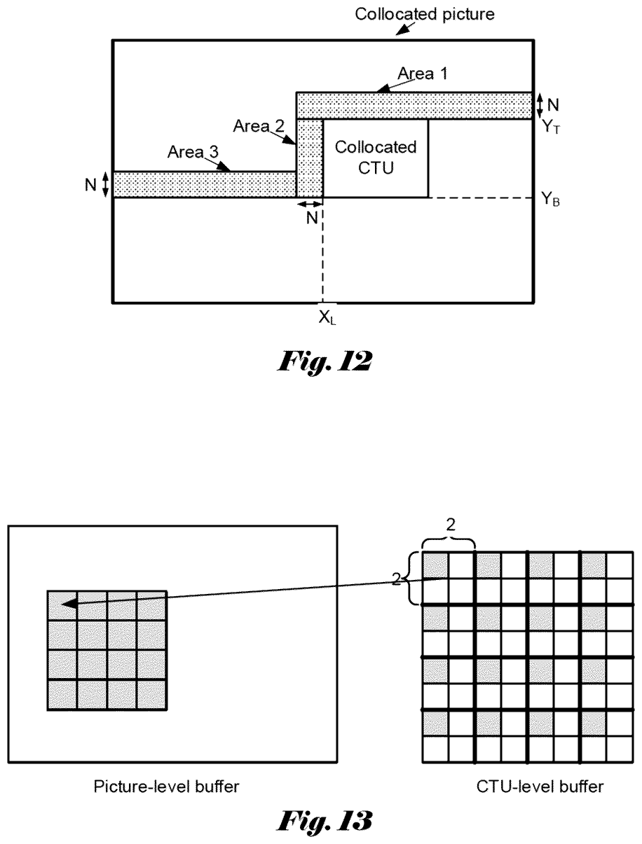

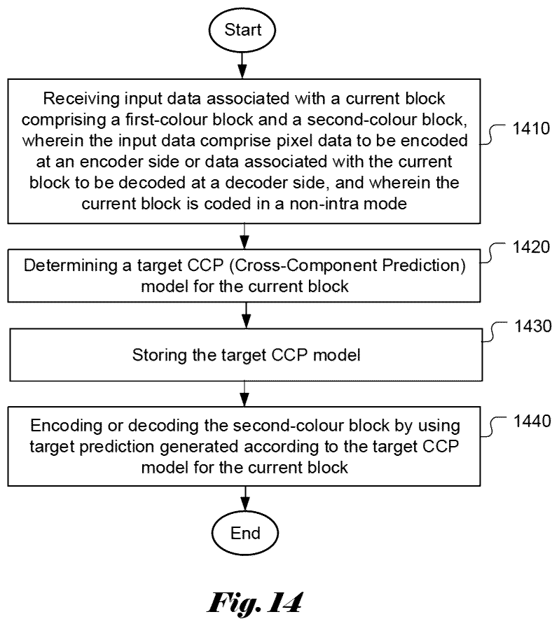

However, if the unit of CTU-level buffer and picture-level buffer are not the same (e.g., i>m or j>n), it should subsample the inter coding or CCM information in CTU-level buffer for saving to the picture-level buffer. Suppose i/m=g and j/n=h, one of each g×h grids of CTU-level buffer is selected to save the inter coding or CCM information to the corresponding position of the picture-level buffer. For example, as shown in FIG. 13, if g=2 and h=2, one selected position of each 2×2 grid is selected to save the inter coding or CCM information to the corresponding position of the picture-level buffer. In one embodiment, the selected position can be the left-above, left-bottom, right-above, or right-bottom of each 2×2 grid. As shown in FIG. 13, the inter coding or CCM information at the left-above position marked in the shaded area of each 2×2 grid is saved to the picture-level buffer. In another embodiment, when subsampling the CCM information in CTU-level buffer for saving to the picture-level buffer, it can conditionally check the prediction modes inside the g×h grids. For example, if more than a percentage of positions inside the g×h grids are intra mode (e.g., more than 50% or 75%), the selected and saved data is CCM information. Otherwise (i.e., most of positions inside the g×h grids are inter mode), the selected and saved data is inter coding information. When selecting the candidate for saving to picture-level buffer, it can follow a predefined scanning order to select the first allowed candidate. For example, if the selected and saved data is CCM information, it can select the first grid inside the g×h grids has CCM information by a predefined scanning order. For another example, if the selected and saved data is inter coding information, it can select the first grid inside the g×h grids has inter coding information by a predefined scanning order.

Due to the buffer for storing inter coding information is shared with CC merge mode, it can check the CU prediction mode (e.g., intra prediction, or inter prediction) to identify if the information stored at a certain buffer position is inter coding or CCM information. In one embodiment, if CU prediction mode is intra prediction, the stored information is CCM information. Otherwise (i.e., CU prediction mode is non-intra prediction), the stored information is inter coding information. In another embodiment, it can set an invalid inter prediction reference index or invalid MV value (e.g., horizontal or vertical MV value) to identify the stored information is CCM information. Otherwise (i.e., valid inter prediction index), the stored information is inter coding information. For example, in VVC standard specification, the inter prediction reference index greater than 2 is invalid, then it can set inter prediction reference index to a value greater than 2 to identify the stored information is CCM information (e.g., inter prediction reference index is 3).

### VI. Constructing a Candidate List

In one embodiment, the candidate list is constructed by adding candidates in a pre-defined order until the maximum candidate number is reached. The candidates added can include all or some of the aforementioned candidates, but not limited to the aforementioned candidates. For example, the pre-defined order can be spatial adjacent candidates, temporal candidates, spatial non-adjacent candidates, historical candidates, and then default candidates.

In another embodiment, if all the pre-defined neighbouring and historical candidates are added but the maximum candidate number is not reached, some default candidates are added into the candidate list until the maximum candidate number is reached.

In one embodiment, the default candidates can be CCLM models. The scaling parameter α is from the set {0, ⅛, −⅛, + 2/8, − 2/8, +⅜, −⅜, + 4/8, − 4/8, . . . , +N/8, −N/8}, where N is a positive integer. For example, the set can be {0, ⅛, −⅛, + 2/8, − 2/8, +⅜, −⅜, + 4/8, − 4/8}. The offset parameter β can be 1/(1<<bit_depth) or can be derived based on neighbouring luma and chroma samples. For example, if the average value of neighbouring luma and chroma samples are lumaAvg and chromaAvg, β=chromaAvg−α·lumaAvg. In one sub-embodiment, the inclusion order of the default candidates can depend on the absolute value and the sign of the scaling parameter α. For example, the default candidates are added into the list in the following order: α=0, ⅛, −⅛, + 2/8, − 2/8, +⅜, −⅜, + 4/8, − 4/8, . . . , +N/8, −N/8.

In another embodiment, a default candidate can be an earlier candidate with a delta scaling parameter refinement. The earlier candidate is a CCLM model. If the scaling parameter of an earlier candidate is α, the scaling parameter of a default candidate is (α+Δα). For example, Δα can be 0, ⅛, −⅛, + 2/8, − 2/8, +⅜, −⅜, + 4/8, − 4/8, . . . , +N/8, −N/8, where N is a positive integer. For example, Δα can be 0, ⅛, −⅛, + 2/8, − 2/8, +⅜, −⅜, + 4/8, − 4/8. The offset parameter β can be derived based on (α+Δα) and the average values of neighbouring luma and chroma samples of the current block. In one sub-embodiment, the earlier candidate is the first CCLM candidate added into the list. In one sub-embodiment, the inclusion order of the default candidates can depend on the absolute value and the sign of the refinement Δα. For example, the default candidates are added into the list in the following order: Δα=0, ⅛, −⅛, + 2/8, − 2/8, +⅜, −⅜, + 4/8, − 4/8, . . . , +N/8, −N/8.

### VII. Removing or Modifying Similar Neighbouring Model Parameters

When inheriting cross-component model parameters from other blocks, it can further check the similarity between the inherited model and the existing models in the candidate list or those model candidates derived by the neighbouring reconstruction samples of the current block (e.g., models derived by CCLM, MMLM, or CCCM using the neighbouring reconstruction samples of the current block). If the model of a candidate parameter is similar with the existing models, the model would not be included into the candidate list.

### VIII. Reordering the Candidates in the List

The candidates in the list can be reordered to reduce the syntax overhead when signalling the selected candidate index.

In one embodiment, the reordering rules can depend on the coding information of neighbouring blocks or the model error. For example, if neighbouring above or left blocks are coded by MMLM, the MMLM candidates in the list can be moved to the head of the current list.

In one embodiment, the reordering rule is based on the model error by applying the candidate model to the neighbouring templates of the current block, and then compare the error with the reconstruction samples of the neighbouring template.

In one embodiment, the input (quantization index, qIdx) of dequantization can be shifted by a derived offset. The derived offset can be pre-defined or selected from a pre-defined candidate set. After dequantizing the shifted input, a shifted dequantized result is obtained and can be further combined with the original not-shifted dequantization result using weighting to form the final dequantization result. In one embodiment, the combination weighting depends on boundary matching. If the original dequantization result has a smaller boundary matching cost, the weight for it will be higher than the shifted dequantization result. In another embodiment, the derived offset is determined by boundary matching. For example, each candidate in the candidate set has a boundary matching cost and the one with the smallest boundary matching cost is used as the shifted offset. In another embodiment, a selection rule is used to decide which quantization index is used and/or which dequantization result is used. The selection rule depends on a pre-defined threshold. For example, if the quantization index is larger than or smaller than the threshold, it can be used for getting the final result. The boundary matching can be used to determine the threshold.

The term “block” in this invention can refer to TU/TB, CU/CB, PU/PB, or CTU/CTB.

The term “LM” in this invention can be viewed as one kind of CCLM/MMLM modes or any other extension/variation of CCLM (e.g. the proposed CCLM extension/variation in this invention). One variation is MMLM that uses thresholds to decide different models for different samples in the current chroma component. Another variation is that for Cb (or Cr), deriving model parameters from multiple collocated luma blocks. The following show more possible variations. The variations of CCLM here mean that some optional modes can be selected when the block indication refers to using one of cross-component modes (e.g. CCLM_LT, MMLM_LT, CCLM_L, CCLM_T, MMLM_L, MMLM_T, and/or an intra prediction mode, which is not one of traditional DC, planar, and angular modes) for the current block. The following shows an example of being convolutional cross-component mode (CCCM) as an optional mode. When this optional mode is applied to the current block, cross-component information with a model, including non-linear term, is used to generate the chroma prediction. The optional mode may follow the template selection of CCLM, so CCCM family includes CCCM_LT CCCM_L, and/or CCCM_T.

The proposed methods (for CCLM) in this invention can be used for any other cross-component modes.

Any combination of the proposed methods in this invention can be applied.

Any of the foregoing proposed methods of storing cross-component model information can be implemented in encoders and/or decoders. For example, any of the proposed methods can be implemented in an inter/intra/prediction/IBC/quantization module of an encoder, and/or an inter/intra/prediction/IBC/quantization module of a decoder. Alternatively, any of the proposed methods storing cross-component model information can be implemented as a circuit coupled to the inter/intra/prediction/IBC/quantization module of the encoder and/or the inter/intra/prediction/IBC/quantization module of the decoder, so as to provide the information needed by the inter/intra/prediction/IBC/quantization module.

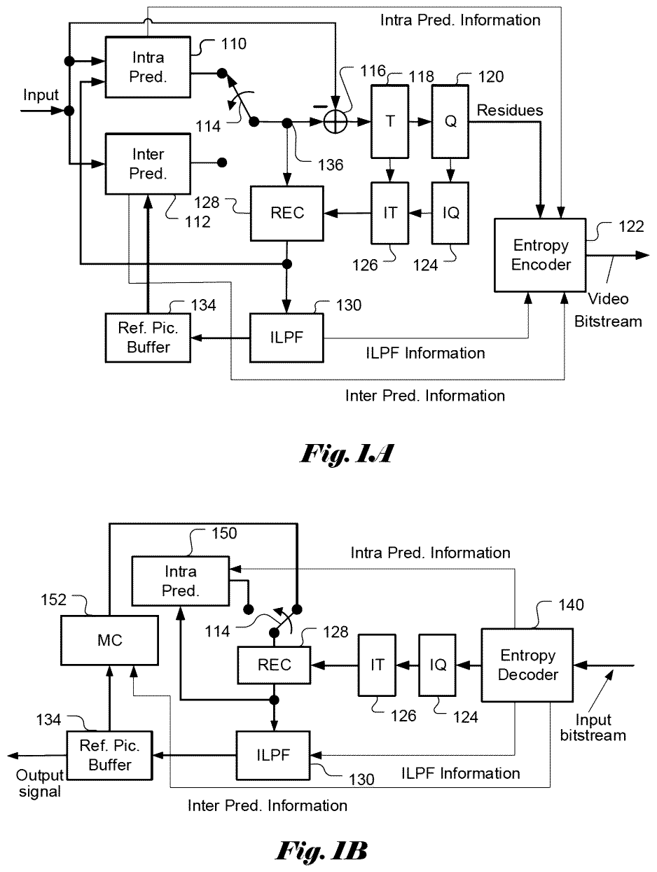

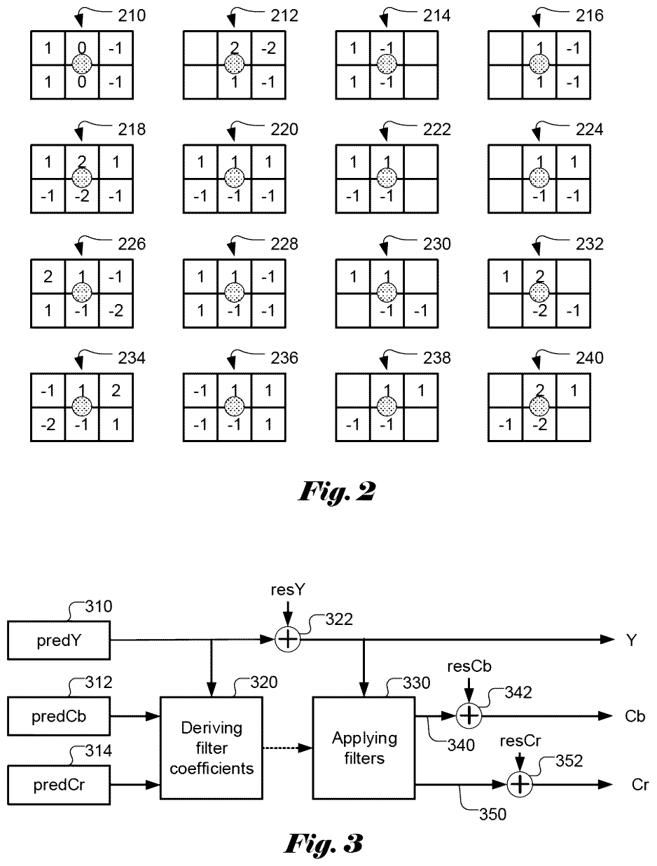

The cross component prediction, where cross-component model information is stored as described above, can be implemented in an encoder side or a decoder side. For example, any of the proposed methods of storing cross-component model information can be implemented in an Intra/Inter coding module (e.g. Intra Pred. 150/MC 152 in FIG. 1B) in a decoder or an Intra/Inter coding module in an encoder (e.g. Intra Pred. 110/Inter Pred. 112 in FIG. 1A). Any of the proposed methods can also be implemented as a circuit coupled to the intra/inter coding module at the decoder or the encoder. However, the decoder or encoder may also use additional processing unit to implement the required cross-component prediction processing. While the Intra Pred./MC units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 14 illustrates a flowchart of an exemplary video coding system that stores cross-component model information to be used or referenced by one or more following coding blocks according to an embodiment of the present invention. According to this method, input data associated with a current block comprising a first-colour block and a second-colour block is receiving in step 1410, wherein the input data comprise pixel data to be encoded at an encoder side or data associated with the current block to be decoded at a decoder side. A target CCP (Cross-Component Prediction) model for the current block is determined in step 1420. The target CCP model is stored in step 1430. The second-colour block is encoded or decoded by using target prediction generated according to the target CCP model for the current block in step 1440.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding colour pictures or video using coding tools including one or more cross component models related modes, the method comprising:
receiving input data associated with a current block comprising a first-colour block and a second-colour block, wherein the input data comprise pixel data to be encoded at an encoder side or data associated with the current block to be decoded at a decoder side, and wherein the current block is coded in a non-intra mode;
determining a target CCP (Cross-Component Prediction) model for the current block;
storing the target CCP model; and
encoding or decoding the second-colour block by using target prediction generated according to the target CCP model for the current block.

2. The method of claim 1, wherein the target CCP model comprises cross-component mode information, CCM (Cross-Component Model) information, or both.

3. The method of claim 1, wherein the target CCP model corresponds to a self-derived cross-component model or inherited cross-component model.

4. The method of claim 1, wherein the target CCP model comprising CCM (Cross-Component Model) information of inherited cross-component models and model parameters.

5. The method of claim 4, wherein the CCM information of the inherited cross-component models comprise CCLM (Cross-Component Linear Model), CCCM (Convolutional Cross-Component Model), CCCM with different filters, or a combination thereof.

6. The method of claim 4, further comprising refining the CCM information based on CCM information stored previously.

7. The method of claim 1, wherein inherited model parameters associated with CCM (Cross-Component Model) information are refined.

8. The method of claim 7, wherein the inherited model parameters are refined with different types of templates and/or different number of lines.

9. The method of claim 1, wherein the target CCP model corresponds to an inherited cross-component model from chroma intra fusion mode.

10. The method of claim 9, wherein the chroma intra fusion mode is derived by fusing a non-cross-component coded intra prediction and a cross-component coded intra prediction.

11. The method of claim 9, wherein when inheriting CCM information from a block or position coded by the chroma intra fusion mode, model parameters for obtaining cross-component coded intra prediction are inherited and further refined.

12. The method of claim 1, wherein the stored target CCP model is used or referenced by one or more following coding blocks.

13. An apparatus for coding colour pictures or video using coding tools including one or more cross component models related modes, the apparatus comprising one or more electronic circuits or processors arranged to:
receive input data associated with a current block comprising a first-colour block and a second-colour block, wherein the input data comprise pixel data to be encoded at an encoder side or data associated with the current block to be decoded at a decoder side, and wherein the current block is coded in a non-intra mode;
determine a target CCP (Cross-Component Prediction) model for the current block;
store the target CCP model; and
encode or decode the second-colour block by using target prediction generated according to the target CCP model for the current block.
